(19) United States
(12) Patent Application Publication
(10) Pub. No.: US 2026/0054517 A1
(43) Pub. Date: Feb. 26, 2026

(54) DECORATIVE PAPER, DECORATIVE BOARD, AND METHODS FOR PRODUCING DECORATIVE PAPER AND DECORATIVE BOARD

(71) Applicant: TOPPAN HOLDINGS INC., Tokyo (JP)

(72) Inventors: Chiho HARADA, Tokyo (JP); Shin Ota, Tokyo (JP)

(73) Assignee: TOPPAN HOLDINGS INC., Tokyo (JP)

(21) Appl. No.: 19/373,309

(22) Filed: Oct. 29, 2025

Related U.S. Application Data
(63) Continuation of application No. PCT/JP2024/016578, filed on Apr. 26, 2024.

(30) Foreign Application Priority Data
May 1, 2023 (JP) 2023-075503

(51) Int. Cl. B44D 5/00

(52) U.S. Cl. CPC B44D 5/00

(57) ABSTRACT

A decorative paper includes a primary film layer, a pattern-printed layer provided on the primary film layer, a high-design-quality protective layer provided on part of the pattern-printed layer, and a high-design-quality resin layer provided on the high-design-quality protective layer to match the high-design-quality protective layer. A decorative board includes the decorative paper and an impregnation resin used for impregnating the decorative paper and cured therein.

### CROSS-REFERENCE TO RELATED PATENT APPLICATIONS

The present application is a Bypass Continuation of International Patent Application No. PCT/JP2024/016578, filed Apr. 26, 2024, which claims priority to and the benefit of Japanese Patent Application No. 2023-075503, filed on May 1, 2023. The contents of these applications are hereby incorporated by reference herein in their entireties.

### TECHNICAL FIELD

The present invention relates to decorative paper, a decorative board, and methods for producing the decorative paper and the decorative board.

### BACKGROUND

A conventional decorative board is obtained by impregnating decorative paper with thermosetting resin, such as melamine resin, and curing the thermosetting resin used for the impregnation. Because such decorative boards have high surface hardness and resistances, such as contamination resistance, wear resistance, heat resistance, and water resistance, the decorative boards are often used as surface materials for furniture such as desks or surface materials for fixtures such as shop counters. There are also decorative boards and decorative paper having a surface resin layer gloss-adjusted with, for example, a matting agent to provide a three-dimensional visual appearance on the surface of the decorative paper and decorative boards.

Patent Literature 1 describes decorative paper for a resin-impregnated decorative board and the resin-impregnated decorative board as gloss-adjusted decorative paper and a decorative board obtained by impregnating the decorative paper with resin. The decorative paper for a resin-impregnated decorative board and the resin-impregnated decorative board described in Patent Literature 1 include base paper, a pattern layer formed by printing a pattern on the base paper, and a liquid-repellent cured film provided on the pattern layer. The liquid-repellent cured film includes a first liquid-repellent cured film covering the entire pattern layer and a second liquid-repellent cured film provided on part of the first liquid-repellent cured film, with the first liquid-repellent cured film and the second liquid-repellent cured film having different levels of glossiness (gloss), and the decorative paper for a resin-impregnated decorative board and the resin-impregnated decorative board described in Patent Literature 1 have a gloss-adjusted design.

However, the decorative paper for a resin-impregnated decorative board and the resin-impregnated decorative board described in Patent Literature 1 may fail to achieve a desired gloss-adjusted design due to seepage of the liquid-repellent cured film into the base paper, resulting in reduced design quality.

Patent Literature 2 describes a decorative sheet and a decorative board including the decorative sheet, and the decorative sheet includes a decorative layer provided on a paper substrate, a release layer provided on the decorative layer in such a way as to match a low-gloss target area in a pattern on the decorative layer, and a high-gross surface layer formed in a region adjacent to the release layer. With the release layer and the surface layer having different levels of gloss, the decorative sheet described in Patent Literature 2 and the decorative board including the decorative sheet have a gloss-adjusted design. The surface layer is formed by impregnating the decorative sheet with a melamine resin and curing the melamine resin.

Furthermore, the decorative sheet described in Patent Literature 2 and the decorative board including the decorative sheet include a coating layer between the decorative layer and the surface and release layers. However, the coating layer may inhibit impregnation with the melamine resin, reducing impregnability. In addition, insufficient impregnation with the melamine resin may reduce solvent resistance. [Citation List][Patent Literature][PTL 1] JP 2018-176484 A [PTL 2] JP 2019-64120 A.

### SUMMARY OF THE INVENTION

In view of the above circumstances, an object of the present invention is to provide decorative paper and a decorative board having improved design quality and impregnability, and methods for producing the decorative paper and the decorative board.

In order to achieve these objects, the present invention proposes the following means.

[1]A decorative paper according to the present invention includes: a primary film layer; a pattern-printed layer provided on the primary film layer; a high-design-quality protective layer provided on part of the pattern-printed layer; and a high-design-quality resin layer provided on the high-design-quality protective layer to match the high-design-quality protective layer.

[2] In the decorative paper according to [1], the high-design-quality protective layer may have a coated area 0.5 times or more and 1.5 times or less the coated area of the high-design-quality resin layer.

[3] In the decorative paper according to [1] or [2], the high-design-quality protective layer may include a thermosetting resin.

[4] In the decorative paper according to [3], the high-design-quality protective layer may include a casein resin or a urethane resin.

[5] In the decorative paper according to [1] or [2], the high-design-quality resin layer may include a thermosetting resin, an ionizing radiation-curable resin, or an ultraviolet radiation-curable resin.

[6] In the decorative paper according to any one of [1] to [5], the high-design-quality resin layer may be provided to match the pattern of the pattern-printed layer.

[7]A decorative board according to the present invention includes: the decorative paper according to any one of [1] to [6]; and an impregnation resin used for impregnating the decorative paper and cured therein.

[8]A decorative paper production method according to the present invention includes: a pattern printing step for forming a pattern-printed layer; a protective layer printing step for forming a high-design-quality protective layer on part of the pattern-printed layer; and a surface resin layer printing step for forming a high-design-quality resin layer to match the high-design-quality protective layer.

[9] In the decorative paper production method according to [8], the protective layer printing step may form the high-design-quality protective layer to have a coated area 0.5 times or more and 1.5 times or less the coated area of the high-design-quality resin layer.

[10] In the decorative paper production method according to [8] or [9], the surface resin layer printing step may form the high-design-quality resin layer to match the pattern of the pattern-printed layer.

[11]A decorative board production method according to the present invention includes: the decorative paper production method according to any one of [8] to [10]; a resin impregnation step for impregnating the decorative paper with an impregnation resin; and a press step for curing the impregnation resin.

### Advantageous Effects of the Invention

According to the decorative paper, the decorative board, and the methods for producing the decorative paper and the decorative board in the present invention, a decorative paper and a decorative board having improved design quality and impregnability, and methods for producing the decorative paper and the decorative board can be provided.

### BRIEF DESCRIPTION OF THE DRAWINGS

FIG. 1 is a schematic cross-sectional view of decorative paper according to an embodiment.

FIG. 2 is a schematic cross-sectional view of a decorative board according to an embodiment.

FIG. 3 is a cross-sectional view of the decorative paper illustrating an example in which the coated area of a high-design-quality protective layer is larger than the coated area of a high-design-quality resin layer.

FIG. 4 is a cross-sectional view of the decorative paper illustrating an example in which the coated area of a high-design-quality protective layer is smaller than the coated area of a high-design-quality resin layer.

FIG. 5 is a flowchart showing an example method for producing the decorative board.

### DETAILED DESCRIPTION

An embodiment of the present invention is described with reference to the drawings.

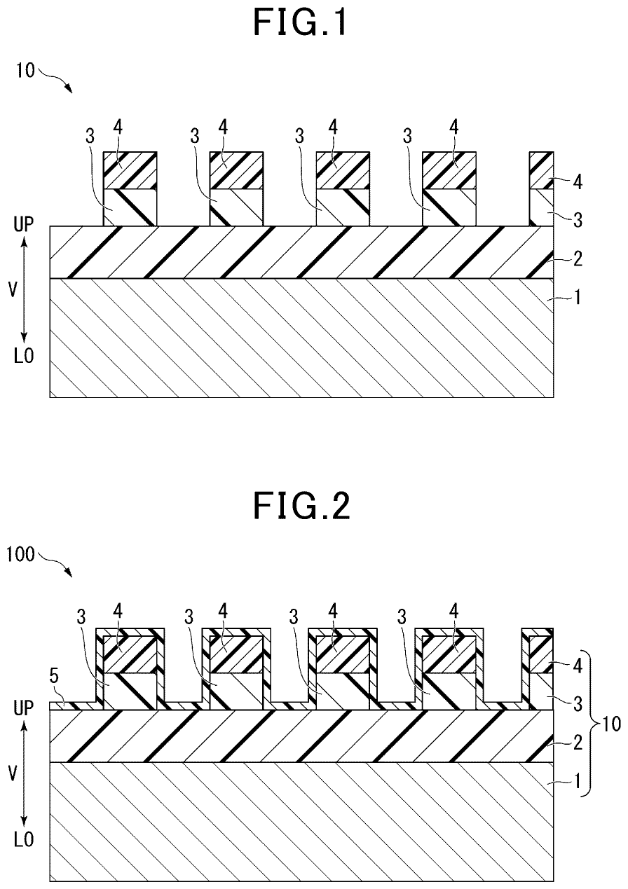

FIG. 1 is a schematic cross-sectional view of decorative paper 10 according to the present embodiment.

FIG. 2 is a schematic cross-sectional view of a decorative board 100 with the decorative paper 10 impregnated with an impregnation resin 5.

In the present embodiment, as illustrated in FIGS. 1 and 2, the thickness direction of the decorative paper 10 and the decorative board 100 is defined as a vertical direction V, the side of the decorative paper 10 on which a primary film layer 1 is provided is defined as a lower side LO in the vertical direction V, and the side opposite to the lower side LO is defined as an upper side UP in the vertical direction V.

The decorative board 100 includes the decorative paper 10 and the impregnation resin 5. The decorative board 100 is formed by impregnating the decorative paper 10 with the impregnation resin 5 and curing the impregnation resin 5 used for the impregnation. When the decorative paper 10 is impregnated with the impregnation resin 5, the impregnation resin 5 penetrates into the decorative paper 10, and as illustrated in FIG. 2, the impregnation resin 5 cures over the surface of the decorative paper 10. The decorative board 100 obtained by impregnation with the impregnation resin 5 and subsequent curing has improved characteristics such as high surface hardness, solvent resistance, contamination resistance, wear resistance, heat resistance, and water resistance.

The impregnation resin 5 is a known thermosetting resin used for a resin-impregnated decorative board. The impregnation resin 5 can be, for example, melamine resin, epoxy resin, diallyl phthalate resin, benzoguanamine resin, urethane resin, alkyd resin, unsaturated polyester resin, phenolic resin, or urea resin. The impregnation resin 5 is dissolved or dispersed in water and used as an aqueous impregnating solution for impregnating the decorative paper 10. It is desirable that the impregnation resin 5 be melamine resin, which has high strength and solvent resistance, contamination resistance, wear resistance, heat resistance, and water resistance.

The decorative paper 10 includes the primary film layer 1, a pattern-printed layer 2, a high-design-quality protective layer 3, and a high-design-quality resin layer 4.

The primary film layer 1 is a layer provided at the lower side LO of the decorative paper 10. The primary film layer 1 is a known fibrous sheet that can be impregnated with the impregnation resin 5. The primary film layer 1 can be, for example, titanium paper, tissue paper, fine paper, unbleached kraft paper, or bleached kraft paper. It is desirable that the primary film layer 1 be titanium paper having improved printability and resin impregnability. The primary film layer 1 may have any thickness and typically have a basis weight of 20 g/m2 or more and 200 g/m2 or less.

The pattern-printed layer 2 is a layer provided on the upper side UP of the primary film layer 1 (the top of the primary film layer 1, or the upper surface of the primary film layer 1) and formed by, for example, printing a pattern such as wood grain, stone grain, or sand grain. The printing method for the pattern-printed layer 2 may be a known printing method such as gravure printing, offset printing, flexographic printing, silk-screen printing, or inkjet printing. For the pattern-printed layer 2, a known printing ink appropriate to the adopted printing method may be used, and it is desirable to use water-based ink. Water-based ink has higher affinity for the aqueous solution of the impregnation resin 5 than oil-based ink, allowing the decorative paper 10 to be impregnated with the impregnation resin 5 rapidly and uniformly. In addition, water-based ink can integrate with the impregnation resin 5 to provide high strength.

Desirable water-based ink used for the pattern-printed layer 2 is a binder resin mainly composed of a casein resin or an emulsion resin. Such a binder resin mainly composed of a casein resin or an emulsion resin has a property of becoming less water-soluble through a drying step after ink printing. During impregnation with the impregnation resin 5, the binder resin is less likely to redissolve in the aqueous solution of the impregnation resin 5 and degrade the pattern of the pattern-printed layer 2 and capable of reducing the likelihood that the impregnation resin 5 will be contaminated by the dissolved pattern-printed layer 2.

The emulsion resin contained in the binder resin may be, for example, acrylic resin, vinyl acetate resin, styrene resin, or urethane resin. In addition to the casein resin or the emulsion resin, the binder resin may also contain, for example, a water-soluble resin such as polyvinyl alcohol or polyacrylamide and a water-soluble polymer such as a polysaccharide or a cellulose derivative in order to improve the stability of the ink.

The high-design-quality protective layer 3 is a layer provided on the upper side UP of the pattern-printed layer 2 (the top of the pattern-printed layer 2, or the upper surface of the pattern-printed layer 2). As illustrated in FIG. 1, the high-design-quality protective layer 3 is, for example, provided on part of the upper side UP of the pattern-printed layer 2. For the high-design-quality protective layer 3, it is desirable to use a material transparent or semitransparent enough to see the pattern of the pattern-printed layer 2. Although the high-design-quality protective layer 3 may be formed from any material, it is desirable to use a thermosetting resin. Examples of resins that are usable for the high-design-quality protective layer 3 include a casein resin and a urethane resin.

The method for forming the high-design-quality protective layer 3 may be a known printing method such as gravure printing, offset printing, flexographic printing, silk-screen printing, or inkjet printing. The high-design-quality protective layer 3 may be formed using a known coating machine.

The high-design-quality resin layer 4 is a layer provided on the upper side UP of the high-design-quality protective layer 3 (the top of the high-design-quality protective layer 3, or the upper surface of the high-design-quality protective layer 3). It is noted that the entire resin of the high-design-quality resin layer 4 may not be disposed on the upper side UP of the high-design-quality protective layer 3 as long as at least a part of the resin of the high-design-quality resin layer 4 is provided on the upper side UP of the high-design-quality protective layer 3. In this case, a part of the high-design-quality resin layer 4 is disposed on the upper side UP of the pattern-printed layer 2 (the top of the pattern-printed layer 2, or the upper surface of the pattern-printed layer 2). An example in which a part of the high-design-quality resin layer 4 is disposed on the upper side UP of the pattern-printed layer 2 is described later.

For the high-design-quality resin layer 4, it is desirable to use a material transparent or semitransparent enough to see the pattern of the pattern-printed layer 2 through the high-design-quality protective layer 3. The high-design-quality resin layer 4 may be formed from a thermosetting resin, an ionizing radiation-curable resin, an ultraviolet radiation-curable resin, or a mixture thereof. Examples of resins usable for the high-design-quality resin layer 4 include thermosetting resins such as melamine resin, epoxy resin, urea resin, phenolic resin, unsaturated polyester resin, diallyl phthalate resin, benzoguanamine resin, urethane resin, aminoalkyd resin, and silicone resin or ionizing radiation-curable resins such as (meth)acrylate resin and unsaturated polyester resin.

The high-design-quality resin layer 4 can be formed by a known printing method such as gravure printing, offset printing, flexographic printing, silk-screen printing, or inkjet printing. The high-design-quality resin layer 4 may also be formed using a known coating machine.

As illustrated in FIG. 1, the high-design-quality resin layer 4 is, for example, provided to match the high-design-quality protective layer 3. It is desirable for the high-design-quality resin layer 4 to be provided to match the pattern of the pattern-printed layer 2. In this case, the high-design-quality protective layer 3 and the high-design-quality resin layer 4 are provided to match the pattern of the pattern-printed layer 2.

It is desirable for the high-design-quality protective layer 3 to have a coated area 0.5 times or more and 1.5 times or less the coated area of the high-design-quality resin layer 4. The coated area refers to an area in plan view as viewed from the upper side UP of the decorative paper 10.

For example, in the cross-sectional view illustrated in FIG. 1, the coated area of the high-design-quality protective layer 3 is 1.0 times the coated area of the high-design-quality resin layer 4. Thus, when the decorative paper 10 illustrated in FIG. 1 is viewed from above the upper side UP (in plan view), the high-design-quality protective layer 3 cannot be seen since it overlaps with the high-design-quality resin layer 4.

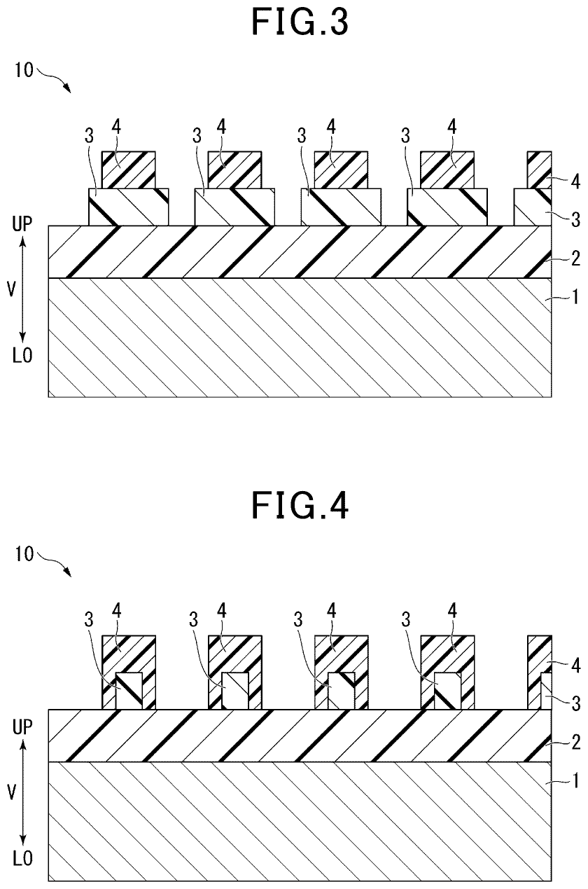

FIG. 3 is a cross-sectional view of the decorative paper 10 illustrating an example in which the coated area of the high-design-quality protective layer 3 is larger than the coated area of the high-design-quality resin layer 4. In FIG. 3, the coated area of the high-design-quality protective layer 3 is about 1.5 times the coated area of the high-design-quality resin layer 4.

FIG. 4 is a cross-sectional view of the decorative paper 10 illustrating an example in which the coated area of the high-design-quality protective layer 3 is smaller than the coated area of the high-design-quality resin layer 4. In FIG. 4, the coated area of the high-design-quality protective layer 3 is about 0.5 times the coated area of the high-design-quality resin layer 4.

The high-design-quality resin layer 4 is provided on the upper side UP of the high-design-quality protective layer 3 and thus less likely to seep into the primary film layer 1. That is, the high-design-quality protective layer 3 inhibits the seepage of the high-design-quality resin layer 4 into the primary film layer 1. Accordingly, this structure reduces the likelihood that the area of the high-design-quality resin layer 4 formed on the upper side UP of the high-design-quality protective layer 3 will be smaller than the desired area due to seepage, resulting in consistent design quality.

Even when the coated area of the high-design-quality protective layer 3 is smaller than the coated area of the high-design-quality resin layer 4 (e.g., in the example in FIG. 4), at least a part of the high-design-quality resin layer 4 is provided on the upper side UP of the high-design-quality protective layer 3. The high-design-quality protective layer 3 can thus inhibit the seepage of the high-design-quality resin layer 4 into the primary film layer 1. When the coated area of the high-design-quality protective layer 3 is smaller than the coated area of the high-design-quality resin layer 4, a part of the high-design-quality resin layer 4 is disposed on the upper side UP of the pattern-printed layer 2, as illustrated in FIG. 4.

Since the high-design-quality protective layer 3, for example, matches the pattern of the pattern-printed layer 2 and lies on part of the upper side UP of the pattern-printed layer 2, the high-design-quality protective layer 3 does not inhibit sufficient impregnation of the decorative paper 10 with the impregnation resin 5. This allows the decorative paper 10 to be sufficiently impregnated with the impregnation resin 5. The decorative board 100 formed by impregnating the decorative paper 10 with the impregnation resin 5 has improved solvent resistance due to the sufficient impregnation with the impregnation resin 5.

With the high-design-quality protective layer 3 provided on part of the upper side UP of the pattern-printed layer 2, and with the high-design-quality resin layer 4 provided to match the high-design-quality protective layer 3, the decorative paper 10 can have both improved design quality and impregnability. The decorative board 100 formed by impregnating the decorative paper 10 with the impregnation resin 5 can also have both improved design quality and solvent resistance.

The high-design-quality protective layer 3 or the high-design-quality resin layer 4 may be gloss-adjusted to provide a gloss appearance or a mat appearance on the decorative paper 10 and the decorative board 100. Examples of methods for gloss-adjusting the high-design-quality protective layer 3 or the high-design-quality resin layer 4 include a method for adding a matting agent to the high-design-quality protective layer 3 or the high-design-quality resin layer 4.

For example, when a matting agent is added to the high-design-quality resin layer 4 but not to the high-design-quality protective layer 3, the high-design-quality resin layer 4 has a lower gloss than the high-design-quality protective layer 3. The matting agent may be added to the high-design-quality protective layer 3 and the high-design-quality resin layer 4 in amounts different enough to produce a gloss difference between the high-design-quality protective layer 3 and the high-design-quality resin layer 4. The gloss difference between the high-design-quality protective layer 3 and the high-design-quality resin layer 4 can create a three-dimensional visual impression through optical illusion perceived by the human eye.

For example, when the pattern-printed layer 2 has a wood grain pattern, the high-design-quality protective layer 3 and the high-design-quality resin layer 4 are provided to match the pattern of the pattern-printed layer 2, with the high-design-quality protective layer 3 and the high-design-quality resin layer 4 arranged on the upper side UP of the vessel area of the wood grain. As a result, the thickness of the high-design-quality protective layer 3 and the high-design-quality resin layer 4 in the vertical direction V can create a three-dimensional tactile impression of the vessel area of the wood grain.

The high-design-quality resin layer 4 disposed to match the pattern may be treated with a matting agent to achieve low gloss, which can provide different levels of gloss (gloss difference) on the upper side UP of the decorative paper 10 between the surface areas with and without the high-design-quality resin layer 4. As a result, the vessel area of the wood grain on which the high-design-quality resin layer 4 is disposed has lower gloss than the area on which the high-design-quality resin layer 4 is not disposed, which can create a three-dimensional visual impression through optical illusion perceived by the human eye.

The matting agent added to the high-design-quality protective layer 3 or the high-design-quality resin layer 4 can be, for example, fine particles composed of inorganic substances such as silica, alumina (α-alumina etc.), calcium carbonate, barium sulfate, kaolinite, and aluminosilicate or organic substances such as polycarbonate, nylon, urethane resin, acrylic resin, styrene resin, and silicone resin.

The matting agent preferably used has an average particle diameter of about 1 to 30 m, and the amount of the matting agent added can be selected as appropriate depending on the desired gloss (glossiness).

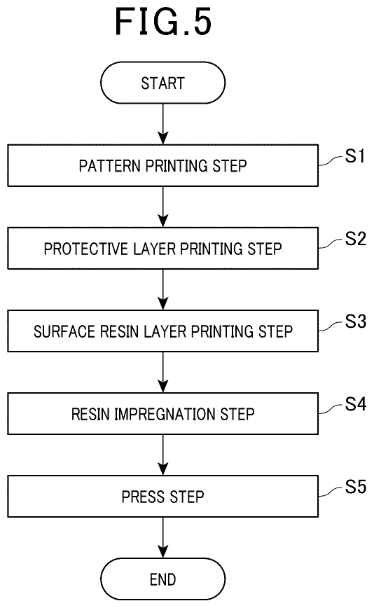

Methods for producing the decorative paper 10 and the decorative board 100 will now be described. FIG. 5 is a flowchart showing an example process for producing the decorative paper 10 and the decorative board 100 using a decorative board production system. The decorative board production system refers to a system that produces the decorative paper 10 and the decorative board 100.

First, the decorative board production system performs step S1 (pattern printing step). In step S1, the pattern-printed layer 2 is formed by printing a pattern on the upper side UP of the primary film layer 1 (the top of the primary film layer 1, or the upper surface of the primary film layer 1).

Next, the decorative board production system performs step S2 (protective layer printing step). In step S2, the high-design-quality protective layer 3 is formed on the upper side UP of the pattern-printed layer 2 (the top of the pattern-printed layer 2, or the upper surface of the pattern-printed layer 2). In this step, the high-design-quality protective layer 3 is formed on part of the upper side UP of the pattern-printed layer 2.

Then, the decorative board production system performs step S3 (surface resin layer printing step). In step S3, the high-design-quality resin layer 4 is formed on the upper side UP of the high-design-quality protective layer 3 (the top of the high-design-quality protective layer 3, or the upper surface of the high-design-quality protective layer 3) to yield the decorative paper 10. In this step, the high-design-quality resin layer 4 is provided to match the high-design-quality protective layer 3. The high-design-quality protective layer 3 thus inhibits the seepage of the high-design-quality resin layer 4 into the primary film layer 1.

For example, the seepage of the high-design-quality resin layer 4 into the primary film layer 1 reduces the gloss or mat appearance achieved by the gloss (high gloss or low gloss) of the high-design-quality resin layer 4, degrading the design quality. In addition, the degree of the seepage of the high-design-quality resin layer 4 varies, reducing the production stability.

The decorative paper 10 has improved design quality and production stability because the high-design-quality protective layer 3 can inhibit the seepage of the high-design-quality resin layer 4 into the primary film layer 1, preventing reductions in design quality and production stability.

In step S2, by forming the high-design-quality protective layer 3 in such a way that the coated area of the high-design-quality protective layer 3 is 0.5 times or more and 1.5 times or less the coated area of the high-design-quality resin layer 4, the seepage of the high-design-quality resin layer 4 into the primary film layer 1 can be further inhibited.

Then, the decorative board production system performs step S4 (resin impregnation step). In step S4, the decorative paper 10 obtained in step S3 is impregnated with the impregnation resin 5. In this step, the decorative paper 10 may be impregnated with the impregnation resin 5 from the upper side UP or from the lower side LO. The impregnation may be performed in several stages from the upper side UP or the lower side LO or may be performed from the upper side UP and the lower side LO at the same time.

In this step, the high-design-quality protective layer 3 formed in step S2 does not inhibit the decorative paper 10 from being impregnated with the impregnation resin 5 because the high-design-quality protective layer 3 is provided on part of the upper side UP of the pattern-printed layer 2. This allows the decorative paper 10 to be sufficiently impregnated with the impregnation resin 5, and the decorative paper 10 has improved impregnability.

Then, the decorative board production system performs step S5 (press step). In step S5, the decorative paper 10 impregnated with the impregnation resin 5 in step S4 is sandwiched between press plates such as metal plates from the upper side UP and the lower side LO, and the decorative paper 10 is compressed and heated from the upper side UP and the lower side LO. The compression and heating cure the thermosetting resin of the impregnation resin 5, forming the decorative board 100. Examples of usable methods for heating and compressing the decorative paper 10 include flat pressing with metal plates and continuous lamination using cylindrical press rollers.

The decorative board 100 obtained in step S5 has improved design quality because the high-design-quality protective layer 3 inhibits the seepage of the high-design-quality resin layer 4 into the primary film layer 1. The decorative board 100 also has improved solvent resistance because the decorative paper 10 included therein has improved impregnability and the decorative paper 10 is sufficiently impregnated with the impregnation resin 5 (e.g., melamine resin).

According to the decorative paper 10, the decorative board 100, and the methods for producing the decorative paper 10 and the decorative board 100 in the present embodiment, the decorative paper 10 and the decorative board 100 include the primary film layer 1, the pattern-printed layer 2 provided on the upper side UP of the primary film layer 1, the high-design-quality protective layer 3 provided on part of the upper side UP of the pattern-printed layer 2, and the high-design-quality resin layer 4 provided on the upper side UP of the high-design-quality protective layer 3 to match the high-design-quality protective layer 3.

As a result, the high-design-quality protective layer 3 inhibits the seepage of the high-design-quality resin layer 4 into the primary film layer 1, and thus the decorative paper 10 and the decorative board 100 have improved design quality. Additionally, since the high-design-quality protective layer 3 does not inhibit the decorative paper 10 from being impregnated with the impregnation resin 5, the decorative paper 10 and the decorative board 100 have improved impregnability. The decorative board 100 is thus sufficiently impregnated with the impregnation resin 5, exhibiting improved solvent resistance.

One embodiment of the present invention has been described in detail above with reference to the drawings. However, the specific configuration should not be limited to this embodiment, but should include design changes within the scope not departing from the spirit of the present invention. Further, the configurations described in the above embodiment and the modification described below can be appropriately combined with each other.

### (Modification 1)

In the above embodiment, the decorative board 100 includes the decorative paper 10 and the impregnation resin 5. However, the decorative board is not limited to this structure. The decorative board may include core paper or a substrate on the lower side LO of the decorative paper 10.

The core paper stacked on the lower side LO of the decorative paper 10 can be, for example, titanium paper, bleached kraft paper, unbleached kraft paper, or glass fiber nonwoven fabric. Alternatively, core paper impregnated with thermosetting resin may be stacked on the lower side LO of the decorative paper 10 and then compressed and heated. The thermosetting resin used for impregnating the core paper can be, for example, melamine resin, epoxy resin, diallyl phthalate resin, benzoguanamine resin, urethane resin, alkyd resin, unsaturated polyester resin, phenolic resin, or urea resin.

The substrate stacked on the lower side LO of the decorative paper 10 can be, for example, a wooden substrate such as a particle board or a medium-density fiberboard (MDF), a plate-like member based on metal such as aluminum or stainless steel, or a composite plate with metal such as aluminum bonded to both sides of a core composed of resin such as polyethylene. When the core paper or the substrate is stacked on the lower side LO of the decorative paper 10, an adhesive may be used. When the core paper or the substrate is stacked on the lower side LO of the decorative paper 10 to form a decorative board, the decorative board can have a predetermined feature such as improved rigidity or adjusted thickness.

The present invention will now be described in detail with reference to Examples. The present invention is not limited to the following Examples.

### Example 1

Titanium paper with a basis weight of 80 g/m2 was prepared as the primary film layer 1. The pattern-printed layer 2 having a pattern was formed on the upper side UP of the primary film layer 1. The high-design-quality protective layer 3 matching the pattern of the pattern-printed layer 2 was formed on the upper side UP of the pattern-printed layer 2.

The high-design-quality resin layer 4 matching the pattern of the pattern-printed layer 2 was formed on the upper side UP of the high-design-quality protective layer 3 to yield the decorative paper 10 in Example 1.

In this example, the coated area of the high-design-quality protective layer 3 is 1.0 times the coated area of the high-design-quality resin layer 4. For the pattern used on the pattern-printed layer 2, the coated area of the high-design-quality resin layer 4 is 50% of the coated area of the pattern-printed layer 2. That is, in Example 1, the coated area of the high-design-quality protective layer 3 is 50% of the coated area of the pattern-printed layer 2.

### Example 2

The decorative paper 10 in Example 2 was obtained by the same method as in Example 1 except that the coated area of the high-design-quality protective layer 3 was 1.5 times the coated area of the high-design-quality resin layer 4.

### Example 3

The decorative paper 10 in Example 3 was obtained by the same method as in Example 1 except that the coated area of the high-design-quality protective layer 3 was 0.5 times the coated area of the high-design-quality resin layer 4.

### Comparative Example 1

The decorative paper in Comparative Example 1 was obtained by the same method as in Example 1 except that the coated area of the high-design-quality protective layer was 2.0 times the coated area of the high-design-quality resin layer. Because the coated area of the high-design-quality resin layer is 50% of the coated area of the pattern-printed layer, the high-design-quality protective layer in Comparative Example 1 is provided over the entire upper surface of the pattern-printed layer.

### Comparative Example 2

The decorative paper in Comparative Example 2 was obtained by the same method as in Example 1 except that the coated area of the high-design-quality protective layer was 0.2 times the coated area of the high-design-quality resin layer. Because the coated area of the high-design-quality protective layer is much smaller than the coated area of the high-design-quality resin layer, the high-design-quality resin layer in Comparative Example 2 cannot be considered to match the high-design-quality protective layer.

### Test 1

The decorative papers in Examples 1 to 3 and Comparative Examples 1 and 2 were each subjected to a design quality evaluation test. In the design quality evaluation test, ten examiners conducted a sensory test for the design quality of the decorative paper to evaluate the appearance of the design of the decorative paper.

The evaluation criteria are based on a three-point scale, and evaluations other than “Poor” are considered acceptable.
Good: seven or more examiners have evaluated the appearance of the design as good.
Fair: five or six examiners have evaluated the appearance of the design as good.
Poor: four or fewer examiners have evaluated the appearance of the design as good.

### Test 2

The decorative papers in Examples 1 to 3 and Comparative Examples 1 and 2 were each subjected to an impregnability evaluation test. In the impregnability evaluation test, a 5 cm square piece was cut from the decorative paper and floated on liquid melamine resin with the high-design-quality resin layer side facing down. Then, the time taken for the melamine resin to soak into the entire surface at the primary film layer side was evaluated.

The evaluation criteria are based on a three-point scale, and evaluations other than “Poor” are considered acceptable.
Good: 20 seconds or less
Fair: 21 seconds or more and 30 seconds or less
Poor: 31 seconds or more

### Test 3

The decorative papers in Examples 1 to 3 and Comparative Examples 1 and 2 were each subjected to a solvent resistance (surface physical property) evaluation test. In the solvent resistance evaluation test, the decorative paper was impregnated with melamine resin as impregnation resin and compressed and heated with a high-pressure press to form a decorative board. The high-design-quality resin layer side (upper side) of the formed decorative board was wiped ten times back and forth using cotton soaked with methyl ethyl ketone (MEK), and loss of pattern on the pattern-printed layer was evaluated.

The evaluation criteria are based on a three-point scale, and evaluations other than “Poor” are considered acceptable.
Good: no pattern loss is observed.
Fair: color transfer to the cotton is observed, but the decorative board shows no pattern loss
Poor: the decorative board shows significant pattern loss.

### Test Results

The results from Tests 1 to 3 are listed in Table 1. Table 1 also shows overall evaluation results determined based on the results from Tests 1 to 3 on the decorative papers in Examples 1 to 3 and Comparative Examples 1 and 2. The evaluation criteria for the overall evaluation are divided into three grades: Good, Fair, and Poor, and evaluations other than Poor are considered acceptable.

The decorative papers in Examples 1 to 3, including the high-design-quality protective layer 3 provided on part of the upper side UP of the pattern-printed layer 2 and the high-design-quality resin layer 4 provided to match the high-design-quality protective layer 3, exhibited good results in all the tests. In particular, the decorative papers in Examples 1 and 2, with the coated area of the high-design-quality protective layer 3 being 0.5 times or more and 1.5 times or less the coated area of the high-design-quality resin layer 4, exhibited better results in Test 1.

The decorative paper in Comparative Example 1, with the high-design-quality protective layer provided over the entire upper surface of the pattern-printed layer, was considered unacceptable in Tests 2 and 3. In Test 1, the decorative paper in Comparative Example 1 exhibited inferior results compared with the decorative papers in Examples 1 and 2 because the melamine resin remained on the surface of the decorative paper and appeared white.

The decorative paper in Comparative Example 2 was considered unacceptable in Test 1 since the coated area of the high-design-quality protective layer is much smaller than the coated area of the high-design-quality resin layer, and the high-design-quality resin layer cannot be considered to match the high-design-quality protective layer.

TABLE 1

| | | | | Compar- | Compar- |
|---|---|---|---|---|---|
| | | | | ative | ative |
| | Exam- | Exam- | Exam- | Exam- | Exam- |
| | ple 1 | ple 2 | ple 3 | ple 1 | ple 2 |
| Test 1 | Good | Good | Fair | Fair | Poor |
| Design Quality | | | | | |
| Test 2 | Good | Good | Good | Poor | Good |
| Impregnability | | | | | |
| Test 3 | Good | Good | Good | Poor | Good |
| Solvent Resistance | | | | | |
| Overall Evaluation | Good | Good | Good | Poor | Poor |

### INDUSTRIAL APPLICABILITY

The present invention can be used for decorative paper including a primary film layer, a pattern-printed layer, a high-design-quality protective layer, and a high-design-quality resin layer, a decorative board, and a method for producing the decorative paper.

[Reference Signs List] 100 Decorative board 10 Decorative paper 1 Primary film layer 2 Pattern-printed layer 3 High-design-quality protective layer 4 High-design-quality resin layer 5 Impregnation resin V Vertical direction UP Upper side LO Lower side

S1 Pattern printing step S2 Protective layer printing step S3 Surface resin layer printing step S4 Resin impregnation step S5 Press step

What is claimed is:

1. A decorative paper comprising:
a primary film layer;
a pattern-printed layer provided on the primary film layer;
a high-design-quality protective layer provided on part of the pattern-printed layer; and
a high-design-quality resin layer provided on the high-design-quality protective layer to match the high-design-quality protective layer.

2. The decorative paper of claim 1, wherein the high-design-quality protective layer has a coated area 0.5 times or more and 1.5 times or less a coated area of the high-design-quality resin layer.

3. The decorative paper of claim 1, wherein the high-design-quality protective layer includes a thermosetting resin.

4. The decorative paper of claim 3, wherein the high-design-quality protective layer includes a casein resin or a urethane resin.

5. The decorative paper of claim 1, wherein the high-design-quality resin layer includes a thermosetting resin, an ionizing radiation-curable resin, or an ultraviolet radiation-curable resin.

6. The decorative paper of claim 1, wherein the high-design-quality resin layer is provided to match a pattern of the pattern-printed layer.

7. A decorative board comprising:
the decorative paper of claim 1; and
an impregnation resin used for impregnating the decorative paper and cured therein.

8. A decorative paper production method comprising:
a pattern printing step for forming a pattern-printed layer;
a protective layer printing step for forming a high-design-quality protective layer on part of the pattern-printed layer; and
a surface resin layer printing step for forming a high-design-quality resin layer to match the high-design-quality protective layer.

9. The decorative paper production method of claim 8, wherein the protective layer printing step forms the high-design-quality protective layer to have a coated area 0.5 times or more and 1.5 times or less a coated area of the high-design-quality resin layer.

10. The decorative paper production method of claim 8, wherein the surface resin layer printing step forms the high-design-quality resin layer to match a pattern of the pattern-printed layer.

11. A decorative board production method comprising:
the decorative paper production method according to claim 8;
a resin impregnation step for impregnating the decorative paper with an impregnation resin; and
a press step for curing the impregnation resin.
